(19) United States
(12) Patent Application Publication
(10) Pub. No.: US 2013/0275126 A1
(43) Pub. Date: Oct. 17, 2013

(54) METHODS AND SYSTEMS TO MODIFY A SPEECH SIGNAL WHILE PRESERVING AURAL DISTINCTIONS BETWEEN SPEECH SOUNDS

(71) Applicant: Robert Schiff Lee, Brooklyn, NY (US)

(72) Inventor: Robert Schiff Lee, Brooklyn, NY (US)

(21) Appl. No.: 13/649,892

(22) Filed: Oct. 11, 2012

Related U.S. Application Data
(60) Provisional application No. 61/545,638, filed on Oct. 11, 2011.

(51) Int. Cl. G10L 21/003

(52) U.S. Cl. CPC G10L 21/003
USPC 704/205

(57) ABSTRACT

Methods and systems to modify an audio signal, such as a speech signal, while preserving aural distinctions between sounds of the audio signal. Methods and systems disclosed herein may be implemented with respect to cellular telephones and portable music devices, such as to reduce and/or prevent hearing loss due. Audio modification may include sweeping through one or more frequency ranges of a speech signal and modifying frequencies within the frequency range as a function of a pattern, such as an infinite rising wave pattern. Speech modification may include adding and subtracting one or more equalization curves to and from the speech signal to vary amplitudes substantially without lateral movement in pitch.

### CROSS REFERENCE TO RELATED APPLICATIONS

This application claims the benefit of U.S. Provisional Patent Application No. 61/545,638, filed Oct. 11, 2011, which is incorporated herein by reference in its entirety.

### BACKGROUND

Auditory fatigue may be defined as a temporary loss of hearing after exposure to sound, which may include a temporary shift of an auditory threshold, also referred to as a temporary threshold shift (TTS). A permanent threshold shift (PTS) may result if sufficient recovery time is not allowed for before continued sound exposure.

Studies have shown that people are heading towards an epidemic of mass hearing loss due to auditory fatigue. Exposure to loud and constant sounds exceeds that of previous generations and is getting worse. Whereas in the past, only people working in relatively extreme environments, such as construction and subway work and the music industry, had contact with such sustained levels of sound, today most people spend many hours per week holding devices to their ears that channel sound directly into the ear canal, at much higher volumes than they realize.

Unlike older land line based telephone phones, cellular telephones phones compress sound into an extremely narrow frequency range, for network efficiency. The reduced bandwidth poses a great risk to hearing. Constant exposure to very limited frequencies tends to destroy cilia in the cochlea (the cells in the inner ear that turn sound waves into biochemical signals for the aural cortex in the brain). Once destroyed, the do not regenerate. Studies are showing that this is likely to develop into significant hearing loss over time. Even more critical is the effect on teenagers and younger people, who are spending more time with cell phones than anyone else. Hearing loss in teenagers increased 30% from 1988 to 2006. One in five teenagers today has hearing loss associated with headphone use.

A complex tone, such as a voice or a note generated by a piano or guitar, includes a fundamental frequency and associated upper harmonics or partials. Although upper harmonics or partials are part of the complex tone or signal, a listener may not consciously hear them. As a result, upper harmonics or partials may be referred to as “ghost notes.” Ghost notes help define the timbre and nuance of a sound. A complex tone having a fundamental frequency of 100 hertz, for example, may include upper harmonics at 200 hz, 300 hz, 400 Hz, etc., at varying amplitudes depending on the source.

A formant is an amplitude peak in a frequency spectrum of a sound or tone.

In speech, vowel sounds may be identified from formants.

Formants are the distinguishing or meaningful frequency components of human speech and of singing. Information needed by a human to distinguish between vowels may be represented quantitatively by the frequency content of the vowel sounds. In speech, these are the characteristic partials that identify vowels to the listener.

The formant with the lowest frequency or harmonic may be referred to as f₁. A second harmonic formant may be referred to as second f₂, and a third harmonic formant may be referred to as f₃. In many cases, the two first formants, f₁ and f₂, are sufficient to disambiguate vowel sounds. The first two formants may determine the quality of vowel sounds in terms of the open/close and front/back dimensions (which have traditionally, though not entirely accurately, been associated with the position of the tongue). The first formant f₁ may have a higher frequency for an open vowel, such as “a,” and a lower frequency for a close vowel, such as “i” or “u.” The second formant f₂ may have a higher frequency for a front vowel, such as “i,” and a lower frequency for a back vowel, such as “u.”

A vowel may have four or more distinguishable formants, and may have more than six. The first two formants are often the most important in determining vowel quality, which may be displayed in terms of a plot of the first formant against the second formant, though this may not be sufficient to capture some aspects of vowel quality, such as rounding.

Conventional human speech coding techniques are described by Bishnu S. Atal & Nikil S Jayan, in Survey of the State of the Art in Human Language Technology, Ch. 10.2., Cambridge University Press (1996), ISBN 0-521-59277-1. The remainder of this background section is reproduced from the survey article.

Coding algorithms seek to minimize the bit rate in the digital representation of a signal without an objectionable loss of signal quality in the process. High quality is attained at low bit rates by exploiting signal redundancy as well as the knowledge that certain types of coding distortion are imperceptible because they are masked by the signal. Our models of signal redundancy and distortion masking are becoming increasingly more sophisticated, leading to continuing improvements in the quality of low bit rate signals. This section summarizes current capabilities in speech coding, and describes how the field has evolved to reach these capabilities. It also mentions new classes of applications that demand quantum improvements in speech compression, and comments on how we hope to achieve such results.

Speech coding techniques can be broadly divided into two classes: waveform coding that aims at reproducing the speech waveform as faithfully as possible and vocoders that preserve only the spectral properties of speech in the encoded signal. The waveform coders are able to produce high-quality speech at high enough bit rates; vocoders produce intelligible speech at much lower bit rates, but the level of speech quality—in terms of its naturalness and uniformity for different speakers—is also much lower. The applications of vocoders so far have been limited to low-bit-rate digital communication channels. The combination of the once-disparate principles of waveform coding and vocoding has led to significant new capabilities in recent compression technology. The main focus of this section is on speech coders that support application over digital channels with bit rates ranging from 4 to 64 kbps.

The capability of speech compression has been central to the technologies of robust long-distance communication, high-quality speech storage, and message encryption. Compression continues to be a key technology in communications in spite of the promise of optical transmission media of relatively unlimited bandwidth. This is because of our continued and, in fact, increasing need to use band-limited media such as radio and satellite links, and bit-rate-limited storage media such as CD-ROMs and silicon memories. Storage and archival of large volumes of spoken information makes speech compression essential even in the context of significant increases in the capacity of optical and solid-state memories.

Low bit-rate speech technology is a key factor in meeting the increasing demand for new digital wireless communication services. Impressive progress has been made during recent years in coding speech with high quality at low bit rates and at low cost. Only ten years ago, high quality speech could not be produced at bit rates below 24 kbps. Today, we can offer high quality at 8 kbps, making this the standard rate for the new digital cellular service in North America. Using new techniques for channel coding and equalization, it is possible to transmit the 8 kbps speech in a robust fashion over the mobile radio channel, in spite of channel noise, signal fading and inter-symbol interference (ISI). The present research is focused on meeting the critical need for high quality speech transmission over digital cellular channels at 4 kbps. Research on properly coordinated source and channel coding is needed to realize a good solution to this problem.

Wireless communication channels suffer from multipath interference producing error rates in excess of 10%. The challenge for speech research is to produce digital speech that can be transmitted with high quality over communication networks in the presence of up to 10% channel errors. A speech coder operating at 2 kbps will provide enough bits for correcting such channel errors, assuming a total transmission rate on the order of 4 to 8 kbps.

The bit rate of 2 kbps has an attractive implication for voice storage as well. At this bit rate, more than 2 hours of continuous speech can be stored on a single 16 Mbit memory chip, allowing sophisticated voice messaging services on personal communication terminals, and extending significantly the capabilities of digital answering machines. Fundamental advances in our understanding of speech production and perception are needed to achieve high quality speech at 2 kbps.

Applications of wideband speech coding include high quality audioconferencing with 7 kHz-bandwidth speech at bit rates on the order of 16 to 32 kbps, and high-quality stereoconferencing and dual-language programming over a basic ISDN link. Finally, the compression of a 20 kHz-bandwidth to rates on the order of 64 kbps will create new opportunities in audio transmission and networking, electronic publishing, travel and guidance, teleteaching, multilocation games, multimedia memos, and database storage.

Speech coders attempt to minimize the bit rate for transmission or storage of the signal while maintaining required levels of speech quality, communication delay, and complexity of implementation (power consumption). We will now provide brief descriptions of the above parameters of performance, with particular reference to speech.

Speech quality is usually evaluated on a five-point scale, known as the mean-opinion score (MOS) scale, in speech quality testing—an average over a large number of speech data, speakers, and listeners. The five points of quality are: bad, poor, fair, good, and excellent. Quality scores of 3.5 or higher generally imply high levels of intelligibility, speaker recognition and naturalness.

The coding efficiency is expressed in bits per second (bps).

Speech coders often process speech in blocks and such processing introduces communication delay. Depending on the application, the permissible total delay could be as low as 1 millisecond (ms), as in network telephony, or as high as 500 ms, as in video telephony. Communication delay is irrelevant for one-way communication, such as in voice mail.

The complexity of a coding algorithm is the processing effort required to implement the algorithm, and it is typically measured in terms of arithmetic capability and memory requirement, or equivalently in terms of cost. A large complexity can result in high power consumption in the hardware.

PCM (pulse-code modulation) is the simplest coding system, a memoryless quantizer, and provides essentially transparent coding of telephone speech at 64 kbps. With a simple adaptive predictor, adaptive differential PCM (ADPCM) provides high-quality speech at 32 kbps. The speech quality is slightly inferior to that of 64 kbps PCM, although the telephone handset receiver tends to minimize the difference. ADPCM at 32 kbps is widely used for expanding the number of speech channels by a factor of two, particularly in private networks and international circuits. It is also the basis of low-complexity speech coding in several proposals for personal communication networks, including CT2 (Europe), UDPCS (USA) and Personal Handyphone (Japan)

For rates of 16 kbps and lower, high speech quality is achieved by using more complex adaptive prediction, such as linear predictive coding (LPC) and pitch prediction, and by exploiting auditory masking and the underlying perceptual limitations of the ear. Important examples of such coders are multi-pulse excitation, regular-pulse excitation, and code-excited linear prediction (CELP) coders. The CELP algorithm combines the high quality potential of waveform coding with the compression efficiency of model-based vocoders. At present, the CELP technique is the technology of choice for coding speech at bit rates of 16 kbps and lower. At 16 kbps, a low-delay CELP (LD-CELP) algorithm provides both high quality, close to PCM, and low communication delay and has been accepted as an international standard for transmission of speech over telephone networks.

At 8 kbps, which is the bit rate chosen for first-generation digital cellular telephony in North America, speech quality is good, although significantly lower than that of the 64 kbps PCM speech. Both North American and Japanese first generation digital standards are based on the CELP technique. The first European digital cellular standard is based on regular-pulse excitation algorithm at 13.2 kbps.

The rate of 4.8 kbps is an important data rate because it can be transmitted over most local telephone lines in the United States. A version of CELP operating at 4.8 kbps has been chosen as a United States standard for secure voice communication. The other such standard uses an LPC vocoder operating at 2.4 kbps. The LPC vocoder produces intelligible speech but the speech quality is not natural.

Research has been directed to providing high quality speech transmission over digital cellular channels at 4 and 8 kbps. Low bit rate speech coders are fairly complex, but the advances in very large scale integration (VLSI). and the availability of digital signal processors have made possible the implementation of both encoder and decoder on a single chip.

Given that there is no rigorous mathematical formula for speech entropy, a natural target in speech coding is the achievement of high quality at bit rates that are at least a factor of two lower than the numbers that currently provide high quality: 4 kbps for telephone speech, 8 kbps for wideband speech and 24 kbps for CD-quality speech. These numbers represent a bit rate of about 0.5 bit per sample in each case.

Another challenge is the realization of robust algorithms in the context of real-life imperfections such as input noise, transmission errors and packet losses.

Finally, an overarching set of challenges has to do with realizing the above objectives with usefully low levels of implementation complexity.

In all of these pursuits, we are limited by our knowledge in several individual disciplines, and in the way these disciplines interact. Advances are needed in our understanding of coding, communication and networking, speech production and hearing, and digital signal processing.

In discussing directions of research, it is impossible to be exhaustive, and in predicting what the successful directions may be, we do not necessarily expect to be accurate. Nevertheless, it may be useful to set down some broad research directions, with a range that covers the obvious as well as the speculative. The last part of this section is addressed to this task.

In recent years, there has been significant progress in the fundamental building blocks of source coding: flexible methods of time-frequency analysis, adaptive vector quantization, and noiseless coding. Compelling applications of these techniques to speech coding are relatively less mature. Complementary advances in channel coding and networking include coded modulation for wireless channels and embedded transmission protocols for networking. Joint designs of source coding, channel coding, and networking will be especially critical in wireless communication of speech, especially in the context of multimedia applications.

Simple models of periodicity, and simple source models of the vocal tract need to be supplemented (or replaced) by models of articulation and excitation that provide a more direct and compact representation of the speech-generating process. Likewise, stylized models of distortion masking need to be replaced by models that maximize masking in the spectral and temporal domains. These models need to be based on better overall models of hearing, and also on experiments with real speech signals (rather than simplified stimuli such as tones and noise).

In current technology, a single general-purpose signal processor is capable of nearly 100 million arithmetic operations per second, and one square centimeter of silicon memory can store about 25 megabits of information. The memory and processing power available on a single chip are both expected to continue to increase significantly over the next several years. Processor efficiency as measured by mips-per-milliwatt of power consumption is also expected to improve by at least one order of magnitude. However, to accommodate coding algorithms of much higher complexity on these devices, we will need continued advances in the way we match processor architectures to complex algorithms, especially in configurations that permit graceful control of speech quality as a function of processor cost and power dissipation. The issues of power consumption and battery life are particularly critical for personal communication services and portable information terminals.

### SUMMARY

Disclosed herein are methods and systems to modify audio signals, while preserving aural distinctions between sounds of the audio signals.

Methods and systems disclosed herein may be implemented to modify speech-base audio, while preserving aural distinctions between sounds of the speech signal.

Methods and systems disclosed herein may be implemented to reduce the possibility of a temporary threshold shift (TTS) becoming a permanent threshold shift (PTS).

Methods and systems disclosed herein may be implemented with respect to, for example and without limitation, cellular telephones and portable music devices, such as to reduce and/or prevent hearing loss due.

Methods and systems disclosed herein may be implemented with digitized audio, analog audio, and combinations thereof. For illustrative purposes, examples are provided herein with reference to digitized audio. Methods and system disclosed herein are not, however, limited to digitized audio, and may be implemented with respect to analog audio.

For illustrative purposes, features are disclosed herein with reference to audio signals, speech signals, and audio tracts. Unless otherwise specified herein, features disclosed herein may be implemented with any one of, and/or combinations of audio signals, speech signals, and an audio tract.

### BRIEF DESCRIPTION OF THE DRAWINGS/FIGURES

FIG. 1 is a graph of speech quality at various bit rates.

FIG. 2 is a frequency spectrum graph to illustrate lateral frequency equalization shifts.

FIG. 3 is another frequency spectrum graph to illustrate vertical or amplitude frequency equalization shifts.

FIG. 4 is a graph of sound pressure versus frequency.

FIG. 5 is a flowchart of a method of modifying frequencies of a speech signal.

FIG. 6 is a block diagram of a computer system configured to modify frequencies of a speech signal.

FIG. 7 is a block diagram of a system 700 to modify an audio signal while preserving aural distinctions between sounds of the audio signals.

FIG. 8 is a block diagram of a communication system to modify frequencies of transmitted and received audio signals while preserving aural distinctions between sounds of the audio signals.

In the drawings, the leftmost digit(s) of a reference number identifies the drawing in which the reference number first appears.

### DETAILED DESCRIPTION

Telephones and, to a greater extent cell phones, are designed to reproduce voice sounds using a relatively limited frequency bandwidth. The purpose of the limited bandwidth is to use the smallest amount of data for communication needed to preserve aural distinctions between important speech sounds.

A human may hear sounds having frequencies within a range of approximately 20 Hz to 20 kHz. A land line telephone may transmit frequencies within approximately 400 Hz to 3400 Hz. A cellular telephone may utilize an even more narrow frequency range or band, and cell phones much narrower still, which may vary depending on the manufacturer and network.

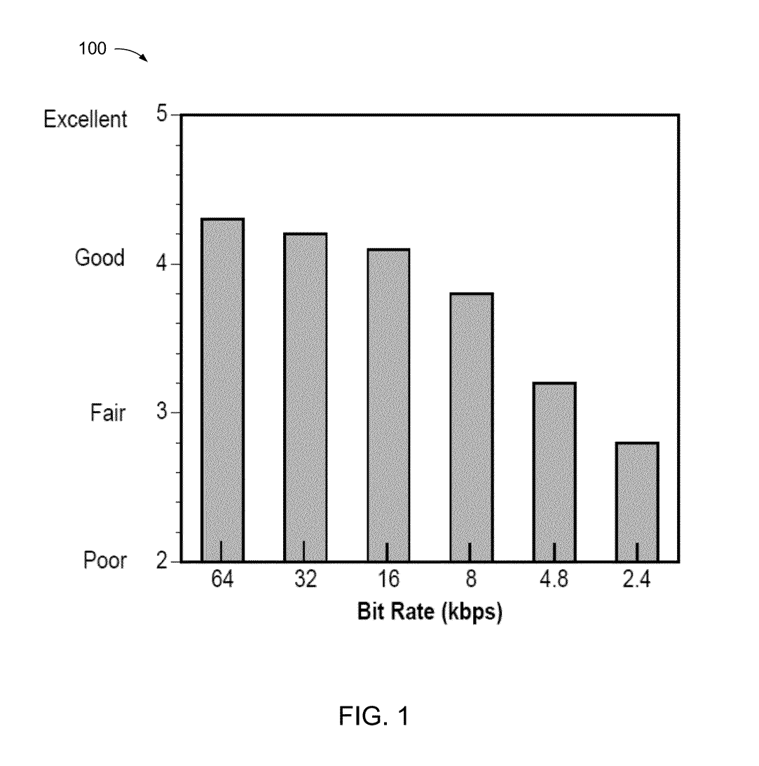

FIG. 1 is a graph 100 of speech quality at various bit rates, from 2.4 to 64 kbps, for relatively narrowband telephone (300 HZ to 3400 Hz) speech. In FIG. 1, speech quality is expressed on the five-point mean opinion score (MOS) scale along the ordinate. FIG. 1 is reproduced from Bishnu S. Atal & Nikil S Jayan, Survey of the State of the Art in Human Language Technology, chapter 10.2.3, Cambridge University Press (1996). As noted therein, the intelligibility of coded speech is sufficiently high at these bit rates.

As disclosed herein, frequency modifications may be made to an audio signal, such as a speech or voice signal, to reduce otherwise potentially continuous or constant exposure to frequencies within an audible range. The frequency modifications may reduce hearing fatigue and potential damage from relatively limited frequency bandwidths.

Frequency modifications may include repeatedly sweeping across an audible signal range of a device to impart frequency changes relatively slowly, so as to be substantially imperceptible to a listener, while providing the device and the listener with respite from constant or nearly constant sound pressure levels that may otherwise be output. Such frequency modifications may substantially unnoticeable and transparent to the listener, and may be viewed as a screen saver for hearing

The frequency modifications may be implemented to preserve aural distinctions between speech sounds.

Frequency modification may include amplification and/or filtering, which may vary with time and/or by frequency, and which may include frequency equalization.

Frequency modification may include frequency-shifting a fundamental frequency of a sound and/or frequency shifting formants of the sound.

Frequency modifications may be implemented with one or more of a variety of techniques, which may be varied for different applications. Example techniques are disclosed below. Methods and systems disclosed herein are not, however, limited to the example techniques herein.

Frequency modification may include sweeping through a frequency range and adding or subtracting frequency amplitudes with multiple sine wave patterns, effectively shifting a fundamental frequency of an incoming pitch. A pattern may include an infinite rising wave pattern, may be employed, which may substantially preclude gaps at the end of a cycle. The frequency modification may include dividing audible frequency range of a device into several bands, and sweeping through each of the frequency ranges. The multiple frequency ranges may be swept substantially simultaneously or in parallel with one another. Frequency sweeping based modification may be implemented with a multiband equalizer/compressor, and may be performed dynamically, or in real-time, with respect to live audio and/or with recorded audio.

Frequency modification may include shifting frequency spectrums of each of multiple audio tracts by a corresponding one of multiple fixed amounts. For example, where the audio tracts correspond to multiple sequential telephone calls, the frequency spectrum of a first one of the telephone calls may be shifted by a first amount, and the frequency spectrum of a second one of the telephone calls may be shifted by a second amount. The fixed amounts may correspond to points on a sine wave, and may be applied sequentially, randomly, and/or with a selection technique. As another example, an audio tract may be divided into multiple sub-tracts, and the frequency spectrum of each sub-tract may be shifted by a corresponding one of multiple fixed amounts.

Frequency modification may include adding and subtracting equalization curves of different shapes, which may be analogous to a standard deviation bell curve. The adding and subtracting may be performed relatively slowly, may be performed randomly or pseudo-randomly, and may include varying only the amplitude up and down, without lateral movement in pitch.

Frequency modification may include frequency-shifting an audio tract, or portions thereof, by an amount sufficient to move out of the range of a hearing loss zone, and small enough to retain characteristics of the audio tract. For example, upper harmonics of the audio tract may frequency-shifted out of the range of the hearing loss zone, which retaining proportions of the harmonics to maintain characteristics of the original audio tract, such as formants or vowel distinctions. As another example, the fundamental frequency of the audio tract may be frequency-shifted, with or without frequency-shifting of the upper harmonics.

Frequency shifting of a fundamental frequency and/or upper harmonics may be implemented with a Fourier transform, and performing an operation on the formants or partials, to preserve or intelligently altering their ratios.

Frequency-shifting of a fundamental frequency and/or upper harmonics may be performed based on a tuning curve of cilia in the basilar membrane, or a frequency band to which each hair cell responds. The frequency band of a hair cell is referred to herein as a critical band of the hair cell. Frequency shifting may include frequency shifting by one critical band for a time sufficient to provide relief to the hair cell.

In addition to modification of an audio tract to protect a listener, harmonic content may be added or synthesized into an audio tract based on spectral analysis of the audio tract. Added harmonic content may include upper-harmonic content. Added harmonic content may represent content that was previously removed or compressed to reduce transmission bandwidth. Upper-harmonic content may be added to improve sound quality, such as to provide greater distinction between sounds, such as between “s” and “f” sounds, and/or sibilants. Harmonic content may be added in a stand-alone implementation and/or in combination with one or more frequency modification techniques disclosed herein to protect a listener.

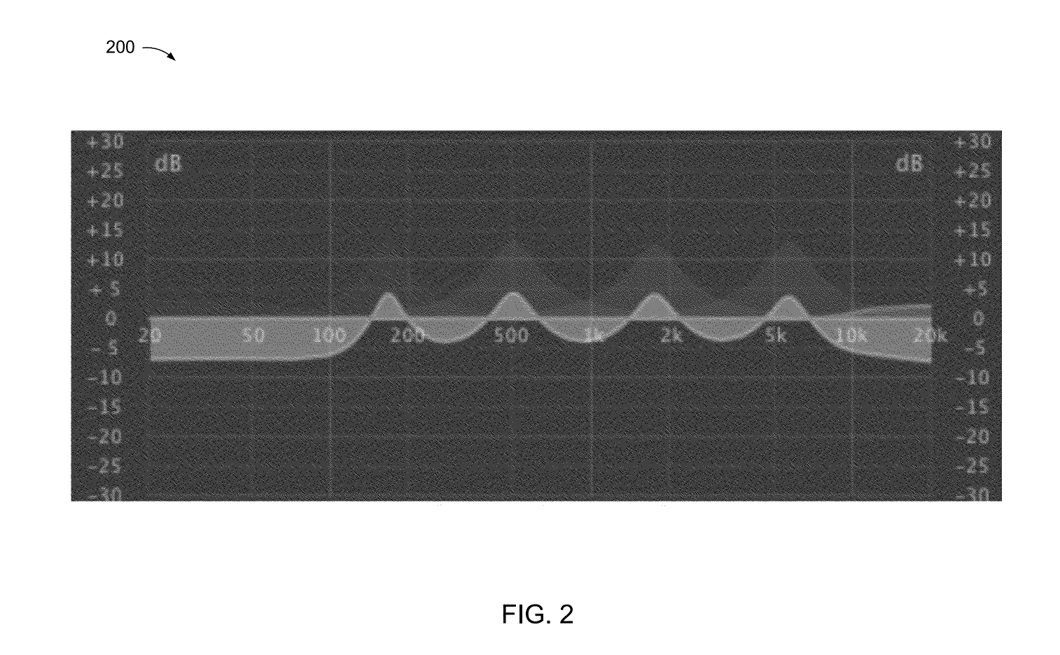

FIG. 2 is a frequency spectrum graph 200 to illustrate lateral frequency equalization shifts.

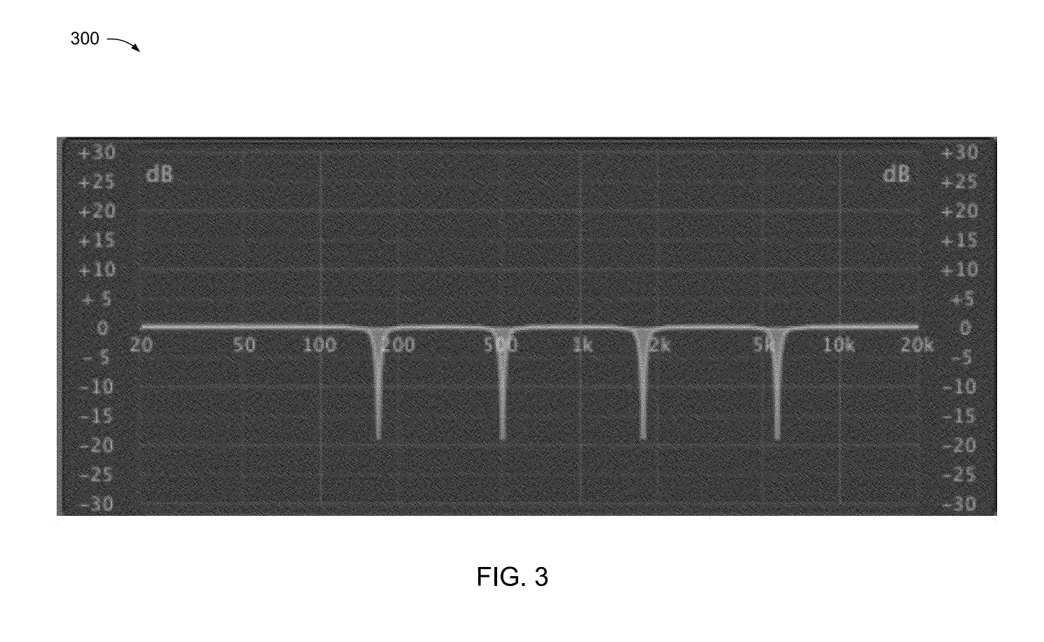

FIG. 3 is a frequency spectrum graph 300 to illustrate vertical (amplitude) frequency equalization shifts.

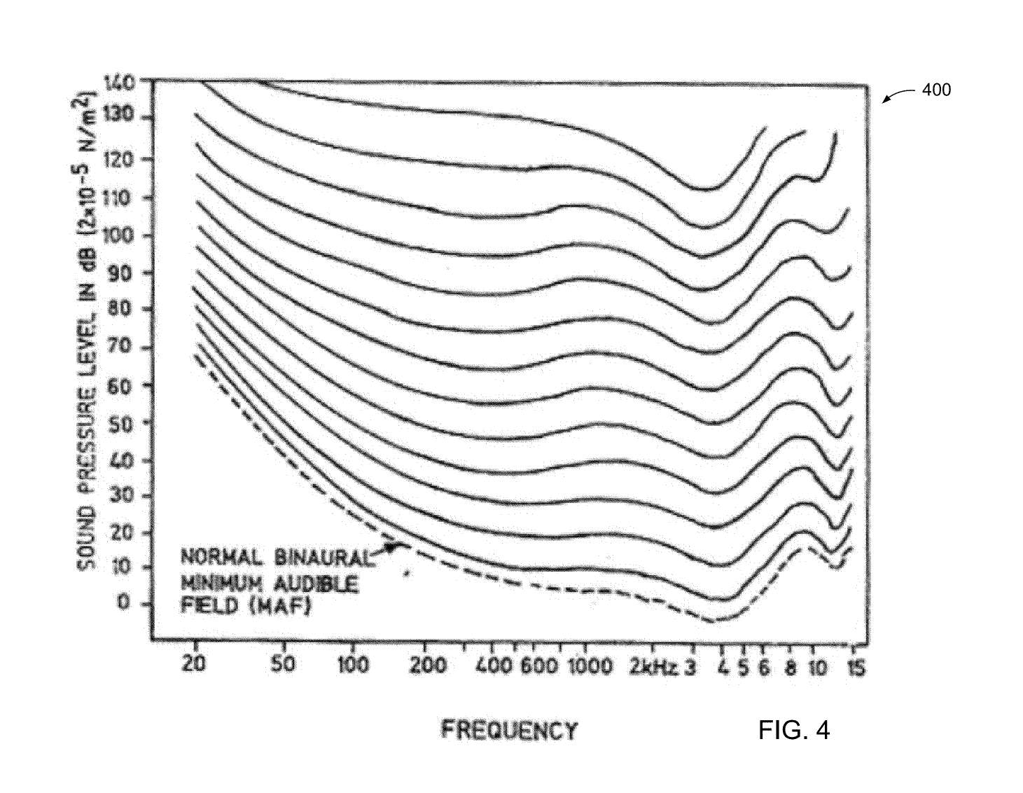

FIG. 4 is a graph 400 of sound pressure versus frequency. Methods and systems disclosed herein may be implemented with respect to data illustrated in FIG. 4.

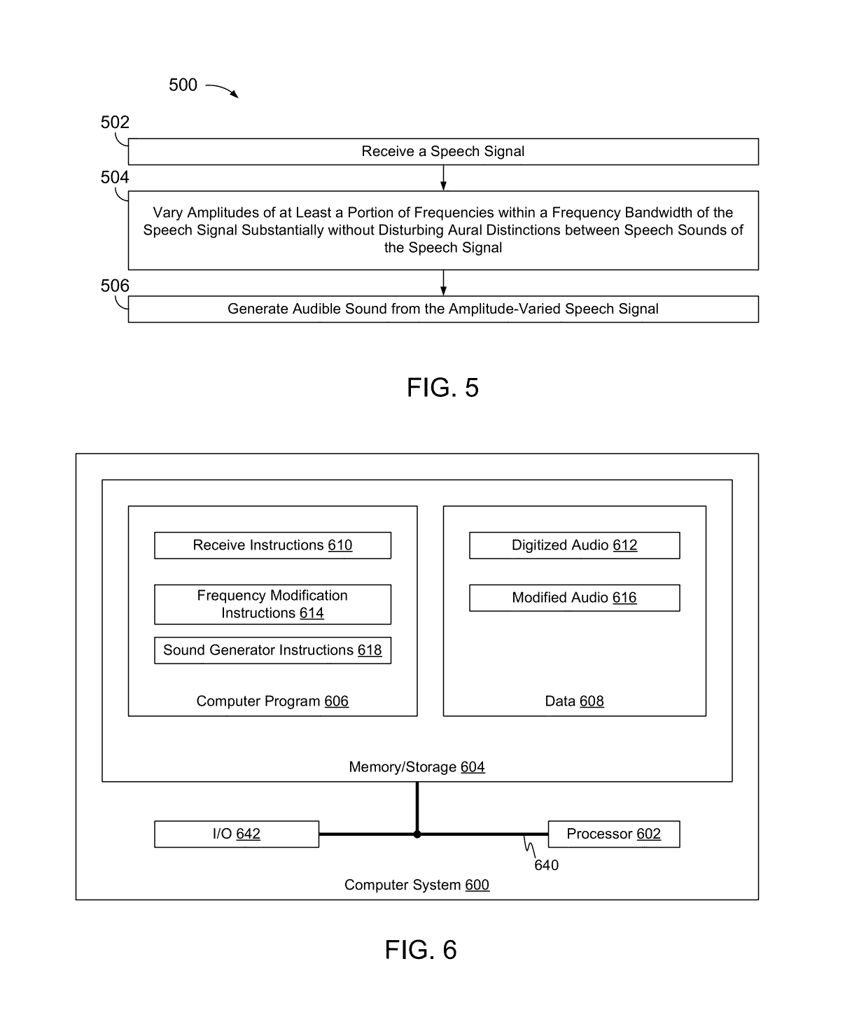

FIG. 5 is a flowchart of a method 500 of modifying frequencies of a speech signal.

At 502, a speech signal is received.

At 504, amplitudes of at least a portion of frequencies within a frequency bandwidth of the speech signal, and/or a frequency spectrum of the speech signal, is modified, substantially without disturbing aural distinctions between speech sounds of the speech signal.

At 506, audible sound is generated from the amplitude-varied speech signal.

Methods and systems disclosed herein may be implemented in hardware, firmware, a computer system, a machine, and combinations thereof, including discrete and integrated circuitry, application specific integrated circuits (ASICs), and/or microcontrollers, and may be implemented as part of a domain-specific integrated circuit package or system-on-a-chip (SOC), and/or a combination of integrated circuit packages.

FIG. 6 is a block diagram of a computer system 600 to modify frequencies of a speech signal.

Computer system 600 includes one or more computer instruction processing units and/or processor cores, illustrated here as a processor 602, to execute instructions of a computer program. Processor 902 may include a general purpose instruction processor, a controller, a microcontroller, or other instruction-based processor. The computer program, which may also referred to as computer program logic or software, may be encoded within a computer readable medium, which may include a non-transitory medium.

Computer system 600 includes one or more of memory, cache, registers, and storage (hereinafter, “memory”) 604.

Memory 604 includes a computer program 606 to cause processor 602 to perform one or more functions in response thereto.

Memory 604 further includes data 608 to be used by processor 602 in executing instructions of computer program 606, and/or generated by processor 606 in response to execution of the instructions.

In the example of FIG. 6, computer program 606 includes receive instructions 610 to cause processor 602 to receive digitized audio 612, which may include digitized speech.

Instructions 606 further includes frequency modification instructions 614 to cause processor 602 to modify one or more frequencies and/or a frequency spectrum of digitized audio 612, or portions thereof, and to store and/or output corresponding modified audio 616.

Frequency modification instructions 614 may include instructions to cause processor 602 to vary amplitudes of at least a portion of frequencies within a frequency bandwidth of digitized audio 612, substantially without disturbing aural distinctions between speech sounds of digitized audio 612, such as disclosed in one or more examples herein.

Frequency modification instructions 614 may include instructions to cause processor 602 to frequency-shift a fundamental and/or one or more upper harmonics of digitized audio 612, substantially without disturbing aural distinctions between speech sounds of digitized audio 612, such as disclosed in one or more examples herein.

Frequency modification instructions 614 may include instructions to cause processor 602 to add upper-harmonic content to digitized audio 612, such as to improve aural distinctions between speech sounds of digitized audio 612, such as disclosed in one or more examples herein.

Computer system 600, or portions thereof, may be implemented in a play-back device or a communication device, such as transmit device, a receive device, and/or an intermediary device. For example, computer system 600, or portions thereof, may be implemented as part of a communication system to modify audio within a transmitting telephone, a receiving telephone, and/or an intermediary device such as a server system.

Where computer system 600, or a portion thereof, is implemented within a receive device, instructions 606 may include sound generator instructions 618 to cause processor 602 to output modified audio 616 to a speaker system to produce audible sound corresponding to modified audio 616.

Computer system 600 may include communications infrastructure 640 to interface amongst devices of computer system 600.

Computer system 600 may include an input/output controller 642 to interface with one or more other devices.

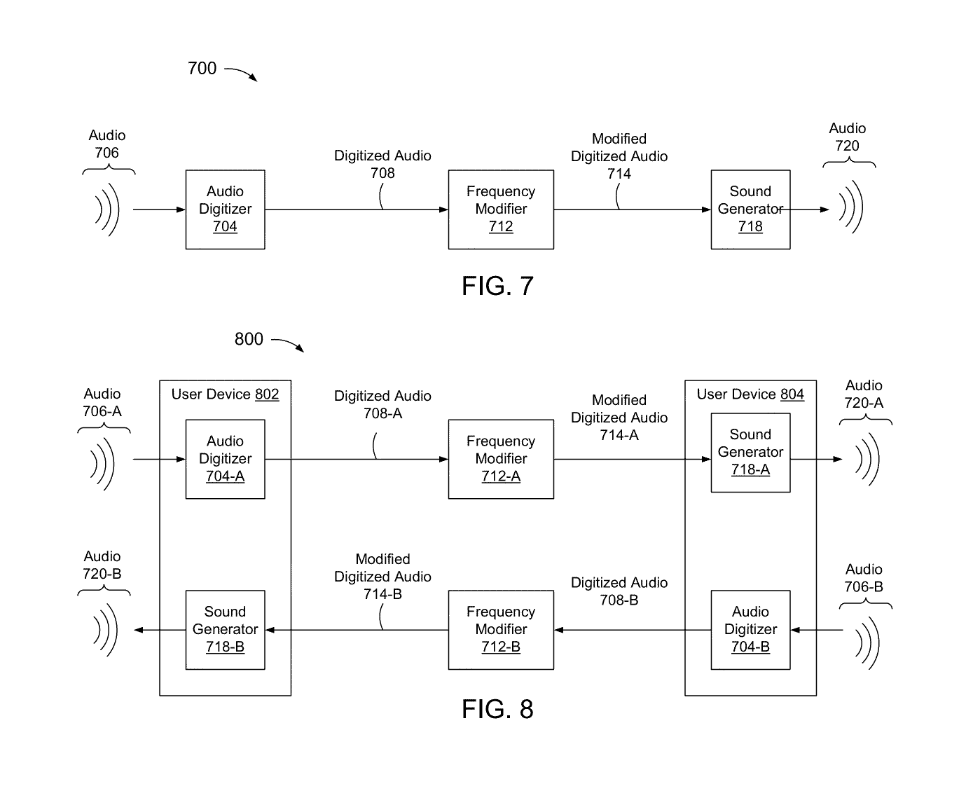

FIG. 7 is a block diagram of a system 700 to modify an audio signal while preserving aural distinctions between sounds of the audio signal.

System 700 includes an audio digitizer 704 to digitize audio 706 and output corresponding digitized audio 708. Audio digitizer 704 may include a sound recording system, such as a music and/or a video recording system, and sound generator 718 may represent a play-back device. Alternatively, or additionally, audio digitizer 704 may include a real-time audio digitizer to digitize speech and/or other audio.

System 700 further includes a frequency modifier 712 to modify one or more frequencies and/or a frequency spectrum of digitized audio 708, or portions thereof, and to store and/or output corresponding modified digitized audio 714, such as described in one or more examples herein.

System 700 further includes a sound generator 718 to produce audible audio 720 from modified audio 714.

Frequency modifier 712, or portions thereof, may be implemented alone and/or in combination audio digitizer 710 and/or sound generator 718.

System 700 may include a transmission system to transmit digitized audio 708 to frequency modifier 712, and/or to transmit modified digitized audio 714 to sound generator 718.

Sound generator 718 may include a receiver system to receive digitized audio 708 or modified digitized audio 714 over a communication link, which may include one or more of a wired communication link, a wireless communication link, and a network communication such, such as an Internet communication link.

FIG. 8 is a block diagram of a communication system 800 to modify frequencies of transmitted and received audio signals while preserving aural distinctions between sounds of the audio signals.

System 800 includes first and second user devices 802 and 804, respectively, each including a corresponding audio digitizer 704 and a sound generator 718. User devices 802 and 804 may represent, for example and without limitation, communication devices, such as portable, wireless, and or mobile/cellular telephones.

System 800 further includes one or more frequency modifiers 712 to modify one or more frequencies and/or a frequency spectrum of digitized audio 708, and to store and/or output corresponding modified digitized audio 714, such as described in one or more examples herein.

A first frequency modifier 712-A may be implemented to modify digitized audio 708-A from user device 802, and to provide corresponding modified digitized audio 714-A to second user device 804. Frequency modifier 712-A, or portions thereof, may be implemented within user device 802, user device 804, and/or an intermediary system, such as a telephone carrier server system.

A second frequency modifier 712-B may be implemented to modify digitized audio 708-B from user device 804, and to provide corresponding modified digitized audio 714-B to user device 802. Frequency modifier 712-B, or portions thereof, may be implemented within user device 804, user device 802, and/or an intermediary system, such as a communication carrier network.

Methods and systems disclosed herein may be implemented with respect to portable and non-portable music devices, such as mp3 players and computers.

Methods and systems disclosed herein may be implemented with respect to aircraft and military communications, and other situations where aural acuity of listeners is of utmost importance.

Frequency modification as disclosed herein may be performed as a function of one or more algorithms.

Methods and systems are disclosed herein with the aid of functional building blocks illustrating the functions, features, and relationships thereof. At least some of the boundaries of these functional building blocks have been arbitrarily defined herein for the convenience of the description. Alternate boundaries may be defined so long as the specified functions and relationships thereof are appropriately performed.

While various embodiments are disclosed herein, it should be understood that they have been presented by way of example only, and not limitation. It will be apparent to persons skilled in the relevant art that various changes in form and detail may be made therein without departing from the spirit and scope of the methods and systems disclosed herein. Thus, the breadth and scope of the claims should not be limited by any of the example embodiments disclosed herein.

What is claimed is:

1. A system, comprising:
a speech generator to generate speech sounds from a speech signal; and
a frequency modifier to vary amplitudes of at least a portion of frequencies within a frequency bandwidth of the speech signal while substantially preserving aural distinctions between speech sounds of the speech signal.

2. The system of claim 1, wherein the frequency modifier is configured to vary amplitudes within a frequency range of up to approximately 400 to 3400 Hz.

3. The system of claim 1, wherein the frequency modifier is configured to sweep through a frequency range of the speech signal and to modify frequencies within the frequency range as a function of a pattern.

4. The system of claim 3, wherein the frequency modifier is further configured to modify the frequencies as a function of an infinite rising wave pattern.

5. The system of claim 3, wherein the frequency modifier is further configured to divide the frequency bandwidth of the speech signal into a plurality of frequency ranges and to sweep through each of the frequency ranges substantially simultaneously.

6. The system of claim 1, wherein the frequency modifier is configured to add and subtract one or more equalization curves to and from the speech signal.

7. The system of claim 6, wherein the frequency modifier is further configured to add and subtract the one or more equalization curves substantially randomly, and to vary amplitudes substantially without lateral movement in pitch.

8. A method, comprising:
receiving a speech signal; and
varying amplitudes of at least a portion of frequencies within a frequency bandwidth of the speech signal substantially while substantially preserving aural distinctions between speech sounds of the speech signal.

9. The method of claim 8, wherein the varying includes varying amplitudes within a frequency range of up to approximately 400 to 3400 Hz.

10. The system of claim 8, wherein the varying includes sweeping through a frequency range of the speech signal and modifying frequencies within the frequency range as a function of a pattern.

11. The method of claim 10, wherein the varying further includes modifying the frequencies as a function of an infinite rising wave pattern.

12. The method of claim 10, wherein the varying further includes dividing the frequency bandwidth of the speech signal into a plurality of frequency ranges and sweeping through each of the frequency ranges substantially simultaneously.

13. The method of claim 8, wherein the varying includes adding and subtracting one or more equalization curves to and from the speech signal.

14. The method of claim 13, wherein the varying further includes adding and subtracting the one or more equalization curves substantially randomly, and varying amplitudes substantially without lateral movement in pitch.

15. A non-transitory computer readable medium encoded with a computer program, including instructions to cause a processor to:
receive a digitized speech signal; and
vary amplitudes of at least a portion of frequencies within a frequency bandwidth of the digitized speech signal while substantially preserving aural distinctions between speech sounds of the speech signal.

16. The computer readable medium of claim 15, further including instructions to cause the processor to vary amplitudes within a frequency range of up to approximately 400 to 3400 Hz.

17. The computer readable medium of claim 15, further including instructions to cause the processor to sweep through a frequency range of the speech signal and modify frequencies within the frequency range as a function of a pattern.

18. The computer readable medium of claim 17, further including instructions to cause the processor to modify the frequencies as a function of an infinite rising wave pattern.

19. The computer readable medium of claim 17, further including instructions to cause the processor to divide the frequency bandwidth of the speech signal into a plurality of frequency ranges and sweep through each of the frequency ranges substantially simultaneously.

20. The computer readable medium of claim 15, further including instructions to cause the processor to add and subtract one or more equalization curves to and from the speech signal, including to vary amplitudes substantially without lateral movement in pitch.
